(19) United States
(12) Patent Application Publication
(10) Pub. No.: US 2008/0147604 A1
(43) Pub. Date: Jun. 19, 2008

(54) Voice Documentation And Analysis Linking

(75) Inventor: Knut Bulow, Katy, TX (US)

Correspondence Address: CONLEY ROSE, P.C.;David A. Rose, P. O. BOX 3267, HOUSTON, TX, 77253-3267, US

(73) Assignee: INFO SERVICES LLC, Katy, TX (US)

(21) Appl. No.: 11/611,528

(22) Filed: Dec. 15, 2006

(51) Int. Cl. G06F 7/00; G06F 17/30; G06F 3/048; G10L 15/26

(52) U.S. Cl. 707/3; 707/101; 715/717; 704/235; 707/E17.006; 707/E17.101; 704/E15.04

(57) ABSTRACT

A method and system for analysis documentation are provided. The method includes issuing a call statement based on a manipulation of data by a user in an application. The method also includes recording a voice file, a screen capture file, and a meta-file associated with the data manipulated by the user. The method further includes linking the voice file, the screen capture file, and the meta-file in an association, and storing the voice file, the meta-file, the screen capture file, and the association such that a user may search according to the meta-file, select a meta-file, and play back the associated voice file while displaying the screen capture file.

### BACKGROUND

When a user manipulates or analyzes data in a computer application, there is a need to comment on or document the user's thoughts and analysis for later users. The comments or documentation may provide later users with insight on how and why the original user analyzed or manipulated the data as he did. Prior to the present disclosure, comments and documentation by a user required that the user type or write his comments and save them in such a fashion that a later user could access them.

Manually typing or writing comments poses several problems. Users may have their progress on a project significantly slowed down by interrupting substantive work to type or write documentation. A user may undervalue comments because the comments are often intended to aid users other than himself, and therefore the user may not devote adequate time to documenting his work for others. Additionally, if comments are typed or written, there is the additional problem that the comments must somehow be stored so that they may be accessed again later. With different users in an enterprise maintaining documentation in their own way (e.g., using different applications, some storing on their hard drive while others storing on a shared drive or even in hard copy), there is a need for a straight forward system for easily accessing and using documentation provided by users.

Therefore, a tool that enables commenting without much labor on the part of the user is desirable. Similarly, a tool that renders documentation easily searchable and accessible is also desirable.

### SUMMARY

These and other features and advantages will be more clearly understood from the following detailed description taken in conjunction with the accompanying drawings and claims.

A software implemented method is provided for analysis documentation. The method includes issuing a call statement based on a manipulation of data by a user in an application. The method also includes recording a voice file, a screen capture file, and a meta-file associated with the data manipulated by the user. The method further includes linking the voice file, the screen capture file, and the meta-file in an association, and storing the voice file, the meta-file, the screen capture file, and the association such that a user may search according to the meta-file, select a meta-file, and play back the associated voice file while displaying the screen capture file based on selection of the associated meta-file.

Also provided is a system for analysis documentation. The system includes a data store, a work station, and an interface. The data store is operable to store a voice file, a screen capture file, a meta-file, and an association between the three. The workstation includes a processor, an operating system, an application in which data may be manipulated, and a voice documentation and analysis software module. The voice documentation and analysis software module, when executed by the processor, causes the processor to issue a call statement based on a manipulation of data by a user in the application, record a voice file and screen capture file to the data store, and record a meta-file associated with the data manipulated by the user to the data store. The voice documentation and analysis software module further causes the processor to link the voice file, the screen capture file, and the meta-file in the data store in an association. The interface is operable to play the voice file while displaying the screen capture file based on selection by a user of the associated meta-file.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a block diagram of a system for analysis documentation in accordance with embodiments of the present disclosure.

FIG. 2 is a flow chart for a method of analysis documentation in accordance with embodiments of the present disclosure.

FIG. 3 illustrates an exemplary general purpose computer system suitable for implementing embodiments of the present disclosure.

### DETAILED DESCRIPTION

It should be understood at the outset that although an illustrative implementation of one embodiment of the present disclosure is illustrated below, the present system may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents.

By implementing analysis documentation in the form of recorded voice files, a user is encouraged to keep adequate documentation that does not require large investments of time to produce. The recorded voice files are linked with meta data and the screen capture for actual data manipulated or analyzed by the user, such that when the user returns to the work, or when another user examines the data, the recorded documentation is readily available and played back along with a display of what the user was actually seeing and doing at the time the recording was made. The linked files may be stored in a data store that is accessible (for instance, a networked data store) and searchable.

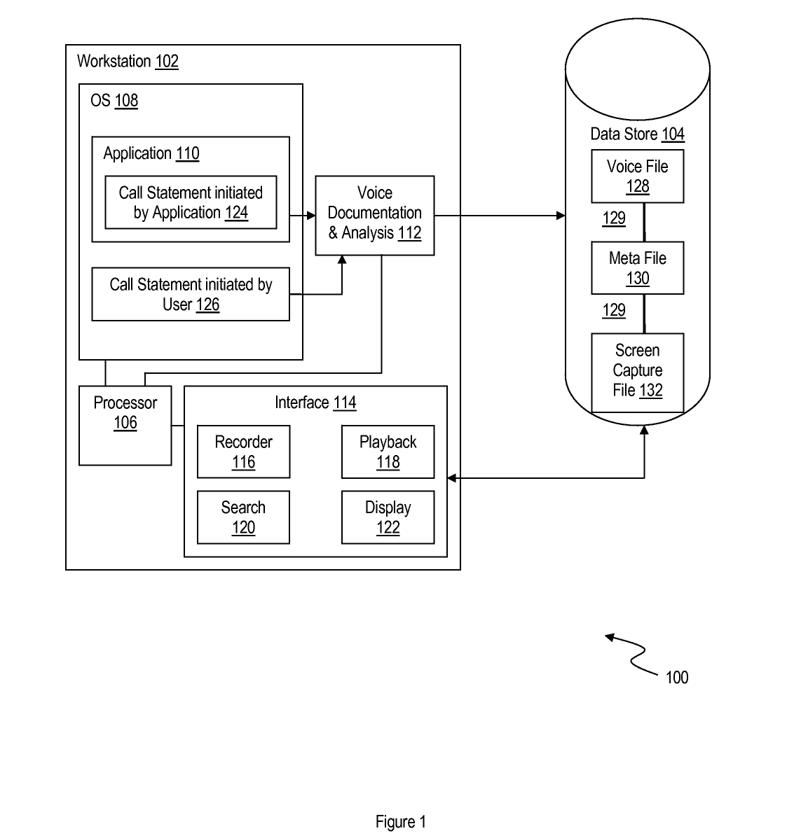

FIG. 1 is a block diagram of a system 100 for analysis documentation in accordance with embodiments of the present disclosure. The system 100 includes a workstation 102 and a data store 104. In various embodiments, the data store 104 may be a component of the workstation 102, operably coupled to the workstation 102 (e.g., an external drive), or remotely located and connected via a computer network connection. The data store 104 is a searchable medium. The data store 104 comprises a computer-readable medium such as volatile memory such as random access memory (RAM), non-volatile storage (e.g., hard disk, compact disc read only memory (CD ROM), read only memory (ROM), etc.) and combinations thereof.

The workstation 102 further includes various hardware and software, including a processor 106, an operating system 108, one or more applications 110, a voice documentation and analysis software module 112, and an interface 114, each of which will be described further in turn below.

The operating system 108 generally controls the workstation 102, enabling the processor 106 to execute the application 110 and/or the voice documentation and analysis module 112. The voice documentation and analysis module 112 may comprise a separate software module that operates in conjunction with the operating system 108, or may comprise a plug-in that operates in conjunction directly with a particular application 110.

The voice documentation and analysis module 112 with the application 110 or the operating system 108. When a user of the workstation 102 performs some action in the application 110, such as manipulating or analyzing data, or inserting changes, a call statement may be initiated to invoke the voice documentation and analysis module 112. The call statement may be a call statement initiated by the application 124 from within the application 110, or may be a call statement initiated by the user 126 by request. For example, the application 110 may initiate a call statement 124 automatically when the user takes certain predetermined actions. Such predetermined actions may be selected to initiate a call statement from within the voice documentation and analysis module 112. For example, in an application for geoscientific analysis, the voice documentation and analysis module may be programmed to automatically initiate a call statement any time the user adds a line for analysis of various strata or makes notations in the data. Alternatively, the user may choose to initiate a call statement 126 by, for example, pressing a predetermined function key.

In either event, the call statement invokes the voice documentation and analysis module 112 to record a voice file 128, record a meta-file 130 associated with the data manipulated by the user at the time the voice file is recorded, record a screen capture file 132 associated with the meta-file 130 and the voice file 128, and link the three with an association 129. The voice documentation and analysis module 112 then stores the voice file 128, the meta-file 130, the screen capture file 132, and the association 129 between the three in the data store 104.

The meta-file 130 may include various data points used to identity what a particular user is doing at the time the associated voice file was made such as, for example, a user identifier, a time stamp, a header identifying the manipulation of data by the user, and a project name, or searchable is a item that can be used instead of a patient name, a vendor, a client, an oil field, etc. The meta-file 130 preferably includes sufficient data for a subsequent user (or returning original user) to search and/or identify a particular file as pertinent for his purposes, and when the user selects the meta-file 130, a display is presented from the screen capture file 132 of what the user who made the voice file 128 was doing (e.g., analysis or data manipulation) at the point in time when the voice file 128 was made. While the display from the screen capture file 132 is shown, the voice file 128 may be played back, thereby giving insight into what the original user was thinking at the time of analysis or data manipulation. Thus, an original user may be reminded of points that he was previously considering, or a subsequent user may be informed of points that a predecessor or colleague was previously considering. Likewise, training in the type of analysis done by the original user may be accomplished.

Optionally, in some applications, such as for example Microsoft Word™, there is a function for commenting by users. The present disclosure enables such comments to be made by recording, rather than typing. Accordingly, when the application is used to access the file (e.g. document) worked on, a designation appears in the file to indicate that a comment is available. When the designation is selected by the user, the voice file 128 is played back while the user is viewing the file that the user who made the file was viewing. In such applications, searching by meta-file 130 is rendered unnecessary because the designation renders the comment easily identified.

Optionally, the voice documentation and analysis module 112 may be operable to convert the voice file 128 into a text file, and additionally link the text file with the meta-file 130 with the association 129. In such an embodiment, the text file is additionally stored in the data store 104. In embodiments wherein the voice file 128 is converted into a text file, the data store 104 may be searched in two ways: 1) according to the data of the meta-files stored therein (e.g., search by user, time stamp, or header), or 2) according to the content of the text files. For voice file to text conversion, any conversion program may be implemented in the voice documentation and analysis module, and may be selected for the degree of accuracy in conversion from voice to text. Likewise, in an embodiment wherein a text file is converted to voice, the translated voice is likewise associated with the meta-file 130, such that it may be searchable according to the meta-file 130.

The interface further includes a recorder 116, playback component 118, a search component 120, and a display 122. The recorder 116 may comprise any commercially available voice file software and hardware, operable to record a voice file upon receiving an instruction from the voice documentation and analysis module 112 to do so. The recorder 116 may record the voice file in any number of audio recording formats, including for example, MPEG 4-Part 3 format, MPEG-1 Layer III (known as MP3) format, MPEG-1 Layer II format, Waveform (.WAV) format, RealAudio format, Windows Media Audio (WMA) format, or other file format for audio file compression as may be developed.

The playback component 118 may comprise any commercially available audio playback software and hardware, operable to play a voice file, such as for example, a MPEG 4-Part 3 file, MPEG-1 Layer III (known as MP3) file, MPEG-1 Layer II file, a .WAV file, a RealAudio file, a Windows Media Audio (WMA) file, or other file format for audio file compression as may be developed.

The search component 120 may comprise a search engine, accessible in the interface 114, operable to find meta-files in the data store 104. The search component may be any search engine operable for use in conjunction with the operating system 108 of the workstation 102. The search component 120 enables the user to input criteria by which a search is conducted, such as the user's identity (e.g., a log-on identifier or employee number), the time stamp, or information in the header. In alternative embodiments in which voice files have been converted into text files, the search component 120 additionally enables the user to input key words as the criteria by which a search is conducted.

The search component 120 identifies any files that meet the criteria by which the search was conducted, and presents the file(s) to the user for examination. The user may select the files one at a time, and the voice file 128 is played while a display is presented of what the user who made the voice file 128 was doing (e.g., analysis or data manipulation) at the point in time when the voice file 128 was recorded. In embodiments when the voice file 128 has additionally been converted to a text file, the text file may also be displayed while the voice file is played.

The display component 122 is operable to generate, from the screen capture file 132, a screen of what the user was seeing and doing at the time the voice file 128 was made. The display component 122 may also display a user interface for the playback component 118 such that a user may pause, play, stop, or repeat the voice file 128 while viewing the screen of what the user was seeing and doing at the time the voice file 128 was made.

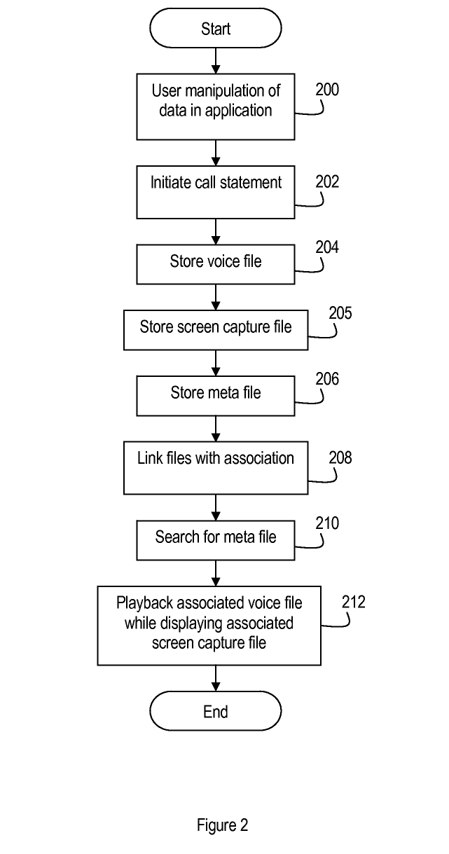

FIG. 2 is a flow chart for a method of analysis documentation in accordance with embodiments of the present disclosure. The method begins with manipulation of data in an application 110 by a user (block 200). The method proceeds with initiating a call statement (block 202). As described above, the call statement may be initiated automatically by the application 110 or operating system 108 based on a particular action by the user, or may be initiated upon request by the user.

Upon the call statement, the voice documentation and analysis module 112 stores a voice file 128 (i.e., recording) from the user (block 204). The voice file 128 may contain comments, analysis, explanation, or any information that the user finds to be pertinent or helpful to himself or subsequent users. The voice file 128 may complement or replace other forms of documentation of data analysis or manipulation by the user. The voice file 128 is stored in the data store 104.

The voice documentation and analysis module 112 also stores a screen capture file 132 of the data the user is seeing at the time the voice file 128 is made (block 205). The voice documentation and analysis module 112 also stores a meta-file 130 (block 206). As described above, the meta-file 130 may include various data points used to identity what, how, or why the user is performing a certain action at the time the voice file 128 was made. The meta-file 130 may include, for example, a user identifier, a time stamp, and a header identifying the manipulation of data by the user. The meta-file 130 preferably includes sufficient data identify the user, project, etc. to associate the display from the screen capture file 132 of what the user was doing (e.g., analysis or data manipulation) at the point in time when the voice file 128 was made with the particular recording from the voice file 128. The meta-file 130 is stored in the data store 104.

The method proceeds as the voice documentation and analysis module links the voice file 128 with the meta-file 130 and the screen capture file 132 by an association 129 that is additionally stored in the data store 104 (block 208).

With the voice file 128, association 129, meta-file 130, and screen capture file 132 saved in the data store, the method proceeds with a search for the meta-file 130 (block 210). The search may be conducted based on criteria entered by the user, such as a date (based on the time stamp), the identity of the user who created the voice file 128 and meta-file 130, or the like. When the user (who is either the same original user or a subsequent user) identifies, from the results of the search, a file that is potentially useful to him, he selects the meta-file 130, which is in turn associated with the voice file 128 and the screen capture file 132. The interface 114 plays back the voice file 128 associated with the meta-file 130 while displaying a screen generated from the screen capture file 132 of what the user who made the voice file 128 was doing (e.g., analysis or data manipulation) at the point in time when the voice file 128 was made (block 212).

Optionally, in alternative embodiments, the voice file 128 may be converted into a text file that is associated with the meta-file 130 and stored, such that the search may additionally be conducted of the contents of text files. In the display 122 in such embodiments, the voice file 128 may be played back and/or the text file may be displayed along with a screen of what the user who made the voice file 128 was doing (e.g., analysis or data manipulation) at the point in time when the voice file 128 was made.

Optionally, a headset may be employed by the user, either wired or wireless (such as Bluetooth™) such that when the user decides to add a recording, or is prompted to do so, the workstation 102 signals the headset by wire or wirelessly to cause a recording to be made as discussed above. In the case of a wireless headset, such as a Bluetooth™ headset, the workstation 102 generates a signal to the Bluetooth™ device to record, and transmit the recording to the workstation 102. Likewise, when a user uses such a headset subsequently to listen to the recording while viewing the screen of what the user who made the voice file 128 was doing, the recording may be heard through the headset or Bluetooth™ device.

In use in a collaborative environment, a plurality of users may be viewing the screen (or the same view in a plurality of screens), while using headsets, for example for 3-D visualization). In such an environment, any one or more of the users may add a recording to the analysis, and in the case when a plurality of different users add recordings, the various explanations may be linked to one another when stored, such that a follow-up user is pointed to all of the related recordings for a particular view.

The benefits of the present disclosure include the ease and speed with which documentation is accomplished, the searchable nature of documentation, and the ability to use the voice documentation and analysis module with varying types of computer applications. By rendering documentation fast and easy, users are encouraged to keep more complete and accurate documentation, and subsequent users can share in the knowledge more easily by referencing the searchable documentation. The voice documentation and analysis module may be applied in global markets with any application in which it is useful to capture the thoughts of the user, including medical applications, geoscientific applications, SCADA applications, engineering applications, technical writing and documentation applications, and the like. Furthermore, the voice documentation and analysis module enables improved training, in that a user preserves an explanation of his work and analysis that may be used for teaching follow-up users.

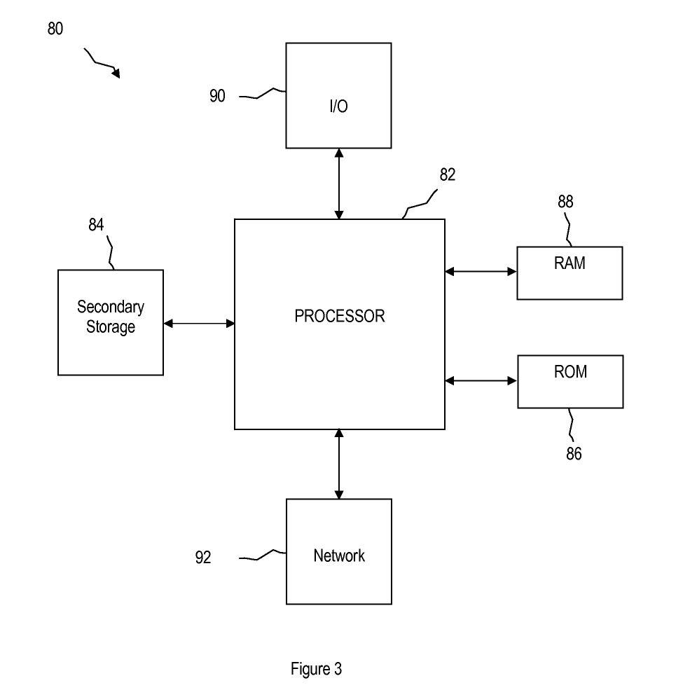

The system described above may be implemented on any general-purpose computer with sufficient processing power, memory resources, and network throughput capability to handle the necessary workload placed upon it. FIG. 3 illustrates a typical, general-purpose computer system suitable for implementing one or more embodiments disclosed herein. The computer system 80 includes a processor 82 (which may be referred to as a central processor unit or CPU) that is in communication with memory devices including secondary storage 84, read only memory (ROM) 86, random access memory (RAM) 88, input/output (I/O) 90 devices, and network connectivity devices 92. The processor may be implemented as one or more CPU chips.

The secondary storage 84 is typically comprised of one or more disk drives or tape drives and is used for non-volatile storage of data and as an over-flow data storage device if RAM 88 is not large enough to hold all working data. Secondary storage 84 may be used to store programs which are loaded into RAM 88 when such programs are selected for execution. The ROM 86 is used to store instructions and perhaps data which are read during program execution. ROM 86 is a non-volatile memory device which typically has a small memory capacity relative to the larger memory capacity of secondary storage. The RAM 88 is used to store volatile data and perhaps to store instructions. Access to both ROM 86 and RAM 88 is typically faster than to secondary storage 84.

I/O 90 devices may include printers, video monitors, liquid crystal displays (LCDs), touch screen displays, keyboards, keypads, switches, dials, mice, track balls, voice recognizers, card readers, paper tape readers, or other well-known input devices. The network connectivity devices 92 may take the form of modems, modem banks, ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. These network connectivity 92 devices may enable the processor 82 to communicate with an Internet or one or more intranets. With such a network connection, it is contemplated that the processor 82 might receive information from the network, or might output information to the network in the course of performing the above-described method steps. Such information, which is often represented as a sequence of instructions to be executed using processor 82, may be received from and outputted to the network, for example, in the form of a computer data signal embodied in a carrier wave

Such information, which may include data or instructions to be executed using processor 82 for example, may be received from and outputted to the network, for example, in the form of a computer data baseband signal or signal embodied in a carrier wave. The baseband signal or signal embodied in the carrier wave generated by the network connectivity 92 devices may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 82 executes instructions, codes, computer programs, scripts which it accesses from hard disk, floppy disk, optical disk (these various disk based systems may all be considered secondary storage 84), ROM 86, RAM 88, or the network connectivity devices 92.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A method for analysis documentation comprising:
issuing a call statement based on a manipulation of data by a user in an application;
recording a voice file and a screen capture file;
recording a meta-file associated with the data manipulated by the user;
linking the voice file, the screen capture file, and the meta-file in an association; and
storing the voice file, the meta-file, the screen capture file and the association.

2. The method according to claim 1, wherein the call statement is automatically initiated without a request from the user.

3. The method according to claim 1, wherein the call statement is initiated upon a request from the user.

4. The method according to claim 1, wherein the meta-file comprises at least one of a user identifier, a time stamp, a header identifying the manipulation of data by the user, and a project name.

5. The method according to claim 1, further comprising searching the stored voice file and meta-file.

6. The method according to claim 4, further comprising searching the stored voice file and meta-file by one of the user identifier, the time stamp, and the header.

7. The method according to claim 1, further comprising playing the voice file while displaying the screen capture file based on selection of the associated meta-file by a user.

8. The method according to claim 1, further comprising:
converting the voice file to a text file; and linking the text file with the meta-file; and
searching the stored text file and meta-file by a keyword search of the text file.

9. A computer-readable medium storing an analysis documentation software program that, when executed by a processor, causes the processor to:
issue a call statement based on a manipulation of data by a user in an application;
record a voice file and a screen capture file;
record a meta-file associated with the data manipulated by the user;
link the voice file, the screen capture file, and the meta-file in an association; and
store the voice file, the meta-file, the screen capture file and the association.

10. The computer-readable medium storing a software program according to claim 9, wherein the call statement is automatically initiated without a request from the user.

11. The computer-readable medium storing a software program according to claim 9, wherein the call statement is initiated upon a request from the user.

12. The computer-readable medium storing a software program according to claim 9, wherein the meta-file comprises at least one of a user identifier, a time stamp, a header identifying the manipulation of data by the user, and a project name.

13. The computer-readable medium storing a software program according to claim 9, the software program being further operable to cause the processor to search the stored voice file and meta-file.

14. The computer-readable medium storing a software program according to claim 12, the software program being further operable to cause the processor to search the stored voice file and meta-file by one of the user identifier, the time stamp, and the header.

15. The computer-readable medium storing a software program according to claim 9, the software program being further operable to cause the processor to play the voice file while displaying the screen capture file based on selection of the associated meta-file by a user.

16. The computer-readable medium storing a software program according to claim 9, the software program being further operable to cause the processor to:
convert the voice file to a text file;
link the text file with the meta-file; and
search the stored text file and meta-file by a keyword search of the text file.

17. A system for analysis documentation comprising:
a data store operable to store a voice file, a screen capture file, a meta-file, and an association between the voice file, the screen capture file, and the meta-file; and
a workstation, the workstation comprising:
a processor;
an operating system;
an application in which data may be manipulated;
a voice documentation and analysis software module that, when executed by the processor, causes the processor to:
issue a call statement based on a manipulation of data by a user in the application;
record the voice file and the screen capture file to the data store;
record a meta-file associated with the data manipulated by the user to the data store;
link the voice file, the screen capture file, and the meta-file in the data store in an association; and
an interface operable to play the voice file while displaying the screen capture file based on selection of the associated meta-file by a user.

18. The system according to claim 17, wherein the data store is one of 1) networked to the workstation, 2) operably coupled to the workstation as an external drive, and 3) a component of the workstation.

19. The system according to claim 17, wherein the interface is further operable to search the data store for a particular stored voice file and associated meta-file.

20. The system according to claim 17, wherein the meta-file comprises at least one of a user identifier, a time stamp, a header identifying the manipulation of data by the user, and a project name, and the interface is further operable to search the stored linked voice file and meta-file by one of the user identifier, the time stamp, the header, and the project name.
